(19) United States
(12) Patent Application Publication
(10) Pub. No.: US 2025/0291367 A1
(43) Pub. Date: Sep. 18, 2025

(54) Driving Control Method and System for Remote Driving Vehicle

(71) Applicants: Hyundai Motor Company, Seoul (KR); Kia Corporation, Seoul (KR)

(72) Inventor: Sun Young Park, Ansan-si (KR)

(21) Appl. No.: 18/823,124

(22) Filed: Sep. 3, 2024

(30) Foreign Application Priority Data
Mar. 18, 2024 (KR) 10-2024-0037330

(51) Int. Cl. G05D 1/85; G05D 1/227; G05D 1/81; G05D 1/86; G05D 109/10; G05D 111/10

(52) U.S. Cl. CPC G05D 1/85; G05D 1/227; G05D 1/81; G05D 1/86; G05D 2109/10; G05D 2111/10

(57) ABSTRACT

The present disclosure relates to a driving control method for a remote driving vehicle that establishes fail-safe control strategies tailored to problem situations occurring during remote driving, thereby enhancing the reliability of remote driving technology. A driving control method and system for a remote driving vehicle may include collecting vehicle information required for remote driving of a vehicle and request information from an occupant of the vehicle, remotely driving the vehicle based on the collected information, determining whether the vehicle is driving abnormally based on information collected during remote driving of the vehicle, and adjusting a behavior of the vehicle to ensure safety when the vehicle is determined to be driving abnormally.

### CROSS-REFERENCE TO RELATED APPLICATION

The present application claims priority to Korean Patent Application No. 10-2024-0037330, filed Mar. 18, 2024, the entire contents of which is incorporated herein for all purposes by this reference.

### BACKGROUND

### Field

The present disclosure relates to a driving control method and system for a remotely driven vehicle.

### Description

Development of an autonomous driving vehicle is closely related to human-like judgment, clarification of responsibilities, enactment of laws and regulations, and so forth.

However, the introduction of remote driving technology, which enables remote control by humans instead of autonomous control by vehicles, is inevitable during the transition period. Thus, there is a growing interest in the remote driving technology.

Therefore, it is necessary to identify potential issues that may arise with the introduction of remote driving and propose solutions to the issues to prevent accidents that may occur during remote driving.

The matters described above as background technology are intended to provide a better understanding of the background of the present disclosure and are not to be construed as an acknowledgment that the present disclosure falls within the purview of the related art already known to those skilled in the art.

### SUMMARY

An object of the present disclosure is to provide a driving control method and system for a remote driving vehicle that establishes fail-safe control strategies tailored to problem situations occurring during remote driving, thereby enhancing the reliability of remote driving technology.

According to one or more example embodiments of the present disclosure, a method may include: collecting, by a controller: vehicle information required for remote driving of a vehicle, and request information from an occupant of the vehicle; remotely driving, by the controller and based on the collected information, the vehicle; determining, by the controller and based on information collected during remote driving of the vehicle, whether the vehicle is driving abnormally; and adjusting, by the controller, a behavior of the vehicle to ensure safety based on the vehicle driving abnormally.

The vehicle information may include: output information reflecting the behavior of the vehicle, and video information obtained by capturing images inside and outside the vehicle.

The method may further include: collecting, based on the vehicle information or the request information not satisfying a predetermined condition, alternative information about the vehicle; and remotely driving the vehicle based on the alternative information.

The alternative information may include at least one of: location information, of the occupant, obtained through a terminal associated with the occupant, or location information, of the vehicle, obtained through a surveillance camera installed on the vehicle.

Determining whether the vehicle is driving abnormally may include: determining that the vehicle is driving abnormally based on at least one of: the vehicle being required to stop, a door being opened, or the occupant attempting to drive the vehicle manually before a destination is reached.

Determining whether the vehicle is driving abnormally may include: determining that the vehicle is driving abnormally based on at least one of: a remote driver vacating a driver's seat, or the remote driver remaining disengaged from driving for more than a threshold amount of time.

Determining whether the vehicle is driving abnormally may include: determining that the vehicle is driving abnormally based on at least one of: a vehicle accident being predicted, the vehicle accident being occurred, or a malfunction signal of a vehicle device being generated.

Determining whether the vehicle is driving abnormally may include: determining that the vehicle is driving abnormally based on a communication disruption between the vehicle and a remote control center.

Determining whether the vehicle is driving abnormally may include: determining that the vehicle is driving abnormally based on at least one of: a simulation device malfunctioning, or detecting a cybersecurity issue.

Adjusting the behavior of the vehicle may include: applying an emergency brake on the vehicle.

Applying the emergency brake may include requesting to the occupant to apply the emergency brake on the vehicle.

Adjusting the behavior of the vehicle may include limiting a drive torque output of the vehicle.

Adjusting the behavior of the vehicle may include alerting a neighboring vehicle.

Adjusting the behavior of the vehicle may include transferring driving control to the vehicle such that the occupant is able to drive the vehicle manually.

According to one or more example embodiments of the present disclosure, a driving control system may include: a vehicle configured to collect information required for remote driving of the vehicle; a remote control center configured to: request signals from the vehicle; remotely drive the vehicle by manipulating a simulator based on the information; determine, based on the information collected by the vehicle during remote driving of the vehicle, whether the vehicle is driving abnormally; and transmit one or more signals to the vehicle to adjust a behavior of the vehicle based on the vehicle driving abnormally. The vehicle may be further configured to, based on the one or more signals, control the behavior of the vehicle.

### BRIEF DESCRIPTION OF THE DRAWINGS

FIG. 1 is a view schematically showing a driving control system for a remote driving vehicle according to the present disclosure.

FIG. 2 is a block diagram sequentially listing a driving control method of a remote driving vehicle according to the present disclosure.

FIG. 3 is a flowchart illustrating a driving control process of a remote driving vehicle according to the present disclosure.

### DETAILED DESCRIPTION

Hereinafter, embodiments disclosed in the present disclosure will be described in detail with reference to the accompanying drawings, but the same reference numerals will be assigned to the similar or same components regardless of drawing numbers and repetitive descriptions will be omitted.

The suffixes “module” and “unit” for the components used in the following description are given or interchangeably used only to facilitate the writing of the specification, without necessarily indicating a distinct meaning or role of their own

When it is determined that the specific description of the related and already known technology may obscure the essence of the embodiments disclosed herein, the specific description will be omitted. Further, it is to be understood that the accompanying drawings are only intended to facilitate understanding of the embodiments disclosed herein and are not intended to limit the technical ideas disclosed herein are not limited to the accompanying drawings and include all the modifications, equivalents, or substitutions within the spirit and technical scope of the present disclosure.

The terms including ordinal numbers such as first, second, and the like may be used to describe various components, but the components are not to be limited by the terms. The terms may only be used for the purpose of distinguishing one component from another.

It is to be understood that when a component is referred to as being “connected” or “coupled” to another component, the component may be directly connected or coupled to the another component, but other components may be interposed therebetween. In contrast, it is to be understood that no other component is interposed when a component is referred to as being “directly connected” or “directly coupled” to another component.

Singular expressions include plural expressions unless the context explicitly indicates otherwise.

In the present specification, terms such as “comprise” or “have” are intended to indicate the presence of implemented features, numbers, steps, manipulations, components, parts, or combinations thereof described in the specification and are not to be understood to preclude the presence or additional possibilities of one or more of other features, numbers, steps, manipulations, components, parts or combinations thereof.

In addition, a unit or a control unit included in the names such as a motor control unit (MCU), a hybrid control unit (HCU), and the like is a term widely used in the naming of controllers that control specific functions of a vehicle and does not mean a generic function unit.

A controller may include a communication device that communicates with other controllers or sensors to control the functions for which the controller is responsible, a memory that stores a driving system or logic instructions and input and output information, and one or more processors that perform determinations, calculations, decisions, and the like required for controlling the functions for which the controller is responsible.

Detailed description of preferred embodiments of the present disclosure with reference to the accompanying drawings is as follows.

A driving control system for a remote driving vehicle according to the present disclosure includes a detection unit (e.g., a vehicle monitoring system) 110 collecting information required for remote driving of the vehicle 100; a remote control center 200 requesting signals from the vehicle for remote driving of the vehicle by manipulating a simulator 210 based on the information collected by the detection unit 110, determining whether the vehicle 100 is driving abnormally based on the information collected by the detection unit 110 during remote driving of the vehicle 100, and requesting signals to regulate the behavior of the vehicle 100 when the vehicle 100 is determined to be driving abnormally; and a vehicle control unit 140 controlling the behavior of the vehicle 100 in accordance with remote control requests and behavior regulation requests from the remote control center 200.

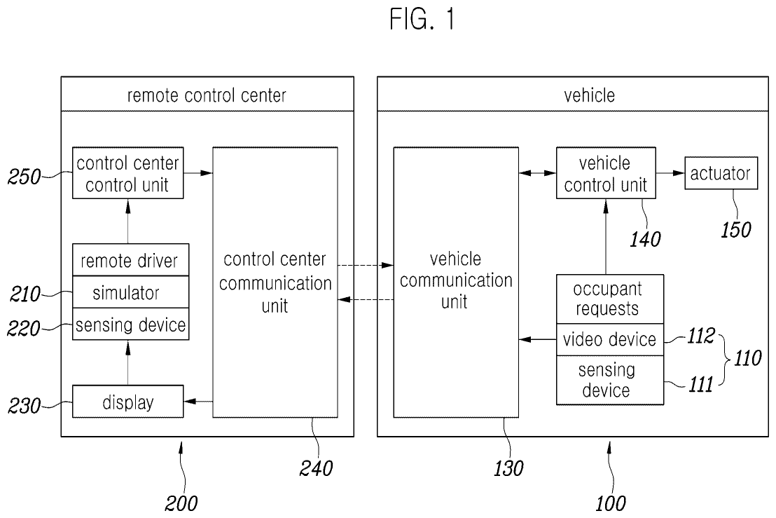

FIG. 1 shows that the present disclosure includes the vehicle 100 and the remote control center 200 and that the vehicle 100 is equipped with the detection unit 110, a vehicle communication unit 130, a vehicle control unit (e.g., one or more processors, a vehicle controller) 140, and an actuator 150.

The detection unit 110 includes a sensing device 111 and a video device 112.

For example, the sensing device 111 may include sensors detecting the manipulation status of mechanical devices (accelerator pedal, brake pedal, steering wheel, etc.) in the vehicle 100, sensors detecting seating status of the occupant, closed status of doors, etc., and sensors detecting the location of the vehicle, the driving direction of the vehicle, and the presence of obstacles around the vehicle and collecting external sound audio information.

The video device 120 may be a camera capturing images in the front and rear of the vehicle 100 and images of the interior of the vehicle 100.

The vehicle communication unit 130 may transmit information collected by the sensing device 111 and the video device 112 to the remote control center 200 as well as transmit request information from an occupant aboard the vehicle 100 to the remote control center 200. The vehicle communication unit 130 may also receive remote control requests transmitted from the remote control center 200 and transmit the received requests to the vehicle control unit 140.

The vehicle control unit 140 serves to control the vehicle 100 upon receiving remote control requests from the remote control center 200. The vehicle control unit 140 may collect request information from an occupant aboard the vehicle 100 and transmit the collected information to the remote control center 200 via communication.

The actuator 150 serves to drive mechanical devices (accelerator pedal, brake pedal, steering wheel, etc.) necessary to operate the vehicle 100 at the request of the vehicle control unit 140.

Next, the remote control center 200 includes a simulator 210, a sensing device 220, a display device 230, a control center communication unit 240, and a control center control unit 250.

For example, the simulator 210 allows a remote driver to drive the vehicle 100 remotely and includes the steering wheel, accelerator pedal, brake pedal, and other convenience devices.

The sensing device 220 may include sensors detecting the manipulation status of the simulator 210 (the driving status of the accelerator pedal, brake pedal, steering wheel, etc. by the remote driver) and may further include sensors detecting the seating status of the remote driver on the driver's seat, line of sight of the remote driver, contact status of the remote driver with the steering wheel to determine the driving status of the remote driver.

The display device 230 serves to display the driving information and inside and outside information of the vehicle 100 transmitted from the vehicle 100 to the remote driver.

The control center communication unit 240 receives information collected from the vehicle 100 and transmits command signals to the vehicle control unit 140 for remote driving of the vehicle 100.

The control center control unit 250 determines whether the vehicle 100 is driving abnormally during remote driving of the vehicle 100. When the vehicle 100 is determined to be driving abnormally, the control center control unit 250 may transmit command signals to regulate the behavior of the vehicle 100 to the vehicle control unit 140 through the control center communication unit 240.

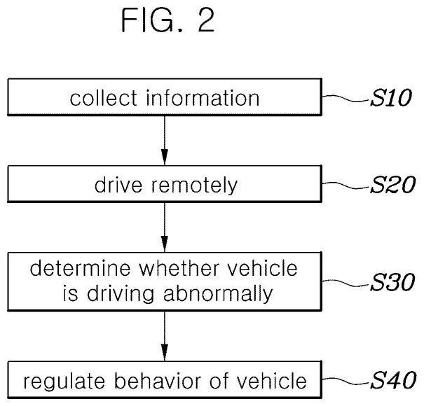

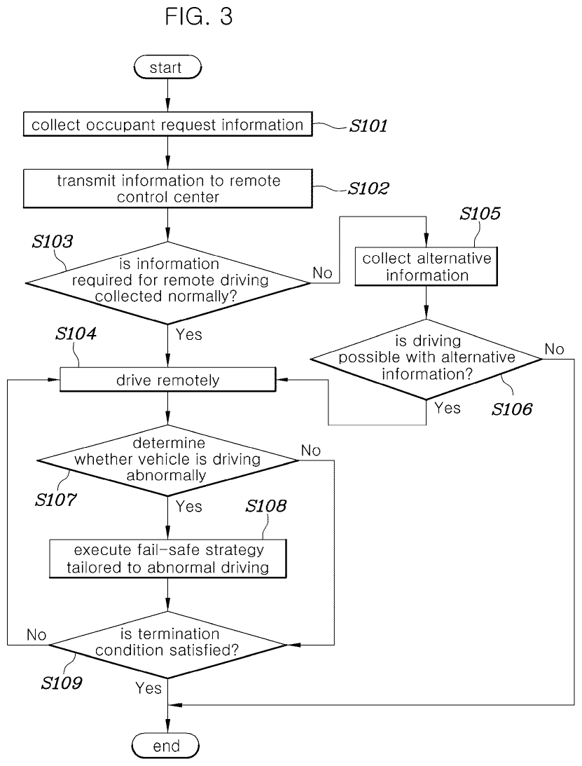

FIGS. 2 and 3 show that a driving control method for a remote driving vehicle 100 of the present disclosure includes collecting by a controller vehicle information required for remote driving of the vehicle 100 along with request information from an occupant aboard the vehicle 100 (S10); performing control by the controller to drive the vehicle 100 remotely based on the collected information (S20); determining by the controller whether the vehicle 100 is driving abnormally based on the information collected during remote driving of the vehicle 100 (S30); and regulating by the controller the behavior of the vehicle 100 to ensure safety when the vehicle 100 is determined to be driving abnormally (S40).

In other words, when the vehicle 100 is driving abnormally during remote driving at the request of an occupant using the remote driving vehicle 100, a fail-safe control strategy tailored to the situation is selected and the target vehicle 100 is controlled by the selected control strategy.

Preferably, controlling the behavior of the target vehicle 100 prevents accidents that may occur in abnormal driving situations, thereby enhancing the reliability of remote driving technology.

In addition, according to the present disclosure, the vehicle information may include output information reflecting the behavior of the vehicle 100 and video information obtained by capturing images inside and outside the vehicle 100.

For example, the output information may be vehicle speed, accelerator pedal opening volume, brake pedal opening volume, gear positions, revolution per minute (RPM), and other data that may be detected by the sensing device 111.

Further, the video information may be obtained by the video device 112, including the boarding status of a passenger, closed status of doors as well as vehicle location, vehicle driving direction, vehicle surroundings, and external sound.

In addition, request information from the occupant may include destinations, temporary stops, emergency braking, etc., requested by the occupant using the remote driving vehicle 100 to the remote control center or the vehicle 100.

These requests may be made through the occupant's smartphone application, in-vehicle voice recognition, or in-vehicle button manipulation, or by connecting to a customer service agent.

However, when the collection of the request information and vehicle information fails, alternative information that may replace the request information and vehicle information may be collected, and control may be performed to drive the vehicle 100 remotely based on the collected alternative information.

In other words, when at least one or more information required for remote driving is not received, alternative information may be collected and used for remote driving.

The alternative information may include the occupant's location information obtained through a terminal carried by the occupant or location information of the vehicle obtained through surveillance cameras installed around the vehicle 100.

In other words, the location and direction information of the vehicle 100 may be collected through the terminal information of the occupant and be put to use and may be obtained through CCTV around the vehicle 100 and be put to use.

In addition, video information obtained by capturing the interior image of the vehicle 100 may be used, or an in-vehicle communication device (SOS) or smartphone application may be used to obtain information from the occupant.

On the other hand, when the vehicle 100 is required to stop, a door is opened, or the occupant attempts to drive the vehicle 100 manually before a destination is reached, the vehicle 100 may be determined to be driving abnormally in the determination of abnormal driving.

For example, when the occupant requests a stop by manipulating a button in the vehicle 100 or using an application before the destination is reached, the vehicle may be determined to be driving abnormally.

In addition, when the occupant aboard the vehicle 100 or a third party attempts to drive the vehicle 100 manually, or when a door of the vehicle 100 is opened while the vehicle 100 is driving, the vehicle may be determined to be driving abnormally.

In addition, when a remote driver operating through simulation vacates the driver's seat or remains disengaged from driving for a certain period or more, the vehicle 100 may be determined to be driving abnormally in the determination of abnormal driving.

It is to be noted that the remote driver's engagement in driving may be determined based on the information about the contact status of the pedal and steering wheel of the simulator 210, line of sight of the remote driver, etc. obtained by the sensing device 220.

In addition, when an accident of the vehicle 100 is predicted or occurs or when a malfunction signal of a vehicle device is generated, the vehicle 100 may be determined to be driving abnormally in the determination of abnormal driving.

For example, when a collision of the vehicle 100 is detected, or when a skid or slip of the vehicle 100 is detected, the vehicle 100 may be determined to be driving abnormally.

In addition, when a warning light of the vehicle 100 such as an engine warning light is on, the vehicle 100 may be determined to be driving abnormally.

When there is poor communication (e.g., communication disruption) between the vehicle 100 and the remote control center 200, or when there are difficulties in transmitting and receiving information, the vehicle 100 may be determined to be driving abnormally in the determination of abnormal driving.

For example, the vehicle may be determined to be driving abnormally when the communication between the remote control center 200 and the vehicle 100 is cut off, when the communication delay between the remote control center 200 and the vehicle 100 equals or exceeds a threshold value, or when the information required for remote driving is not collected normally at the remote control center 200.

In addition, when the behavior of the remote driver and the behavior of the vehicle 100 do not match, the vehicle may be determined to be driving abnormally.

In addition, when it is determined that normal driving is impossible, when cybersecurity issues such as hacking arise, or when the simulation device malfunctions, the vehicle is determined to be driving abnormally.

Further, when a third party demands a stop like when the police command a stop, the vehicle is determined to be driving abnormally.

On the other hand, according to the present disclosure, control may be performed to apply an emergency brake on the vehicle 100 in the regulation of the behavior of the vehicle when the vehicle 100 is determined to be driving abnormally.

Preferably, control may be performed to apply the emergency brake on the vehicle 100 by manipulating the simulator 210.

In addition, the occupant may be requested to apply the emergency brake on the vehicle 100 in the event of emergency braking of the vehicle 100.

In other words, when the driving control of the vehicle 100 is transferred from the remote control center 200 to the vehicle 100, application of the emergency brake on the vehicle 100 may be requested and then the driver may manipulate the emergency brake to brake the vehicle 100.

Further, when a physical brake is provided in a place other than the driver's seat side of the vehicle 100, the occupant may be requested to apply that particular brake for emergency braking of the vehicle 100, or emergency braking may be requested through an application.

In addition, when the vehicle 100 is determined to be driving abnormally, control may be performed to limit the output of the vehicle 100 in the regulation of the behavior of the vehicle.

For example, the output of the vehicle 100 may be limited by limiting the maximum vehicle speed of the vehicle 100.

In addition, the output of the vehicle 100 may be limited by limiting the maximum drive torque of the vehicle 100.

Further, when the behavior of the vehicle 100 is regulated in the regulation of the behavior of the vehicle, neighboring vehicles may be alerted thereto.

In other words, notifying neighboring vehicles of dangerous situations, emergency braking, output (e.g., drive torque) limiting, etc. of the remote driving vehicle 100 through hazard lights or alarm sounds may prevent accidents.

In addition, when the vehicle 100 is determined to be driving abnormally, control may be performed to transfer driving control to the vehicle 100 so that the occupant is enabled to drive the vehicle 100 manually in the regulation of the behavior of the vehicle if the behavior of the vehicle 100 is beyond control.

For example, when a problem such as a system failure of the remote control center 200 or a communication breakdown between the remote control center 200 and the vehicle 100 renders normal control of the vehicle 100 impossible, control is performed to transfer driving control of the remote control center 200 to the vehicle 100 so that the occupant of the vehicle 100 is enabled to manipulate the vehicle 100 manually.

A driving control process of a remote driving vehicle is described by way of example in the following.

FIG. 3 shows that when a passenger using a remote driving vehicle 100, such as a taxi, boards the vehicle 100 and requests a destination, vehicle information required for remote driving is collected along with the destination information requested by the passenger (S101).

The collected request information and vehicle information are transmitted to the remote control center 200 (S102).

The remote control center 200 determines whether the information required for remote driving is collected normally (S103).

When the determination result in S103 indicates that the information is collected normally, the vehicle 100 is driven remotely based on the collected information (S104).

In contrast, when the determination result in S103 indicates that the request information and vehicle information required for remote driving are not collected normally, alternative information that may replace the request information and vehicle information is collected (S105).

Whether the vehicle 100 may be driven remotely is determined based on the collected alternative information (S106).

When the determination result in S106 indicates that driving is possible with the alternative information, the vehicle 100 is driven remotely based on the alternative information (S104).

On the other hand, whether an abnormal driving situation of the vehicle 100 occurs is monitored based on the information collected by the remote control center 200 during remote driving of the vehicle 100 (S107).

When an abnormal driving situation occurs during monitoring, a control strategy is executed in response to the abnormal driving situation to prevent an accident of the remote driving vehicle 100 (S108).

Further, whether a driving termination condition such as arrival at a destination or a request to terminate driving from a driver, the remote control center 200, or an occupant during remote driving of the vehicle 100 is satisfied is determined. When the driving termination condition is satisfied, the remote driving control is terminated (S109).

According to the present disclosure, when the vehicle 100 is driving abnormally during remote driving, selecting fail-safe control strategies tailored to the situation and controlling the target vehicle 100 by the selected control strategies in the manner described above prevent accidents that may occur in abnormal driving situations, thereby enhancing the reliability of remote driving technology.

A driving control method for a remote driving vehicle to achieve the object described above includes collecting by a controller vehicle information required for remote driving of the vehicle along with request information from an occupant aboard the vehicle; performing control by the controller to drive the vehicle remotely based on the collected information; determining by the controller whether the vehicle is driving abnormally based on the information collected during remote driving of the vehicle; and regulating by the controller behavior of the vehicle to ensure safety when the vehicle is determined to be driving abnormally.

The vehicle information may include output information reflecting the behavior of the vehicle and video information obtained by capturing images inside and outside the vehicle.

When the collection of request information and vehicle information fails, alternative information that may replace the request information and vehicle information may be collected, and control may be performed to drive the vehicle remotely based on the collected alternative information.

The alternative information may include the occupant's location information obtained through a terminal carried by the occupant or the location information of the vehicle obtained through surveillance cameras installed around the vehicle.

When the vehicle is required to stop, the door is opened, or the occupant attempts to drive the vehicle manually before a destination is reached, the vehicle may be determined to be driving abnormally in the determination of abnormal driving.

When a remote driver operating through simulation vacates the driver's seat or remains disengaged from driving for a certain period or more, the vehicle may be determined to be driving abnormally in the determination of abnormal driving.

When a vehicle accident is predicted or occurs or when a malfunction signal of a vehicle device is generated, the vehicle may be determined to be driving abnormally in the determination of abnormal driving.

When there is poor communication between the vehicle and the remote control center or when there are difficulties in transmitting and receiving information, the vehicle may be determined to be driving abnormally in the determination of abnormal driving.

When a simulation device malfunctions or when a cybersecurity issue arises, the vehicle may be determined to be driving abnormally in the determination of abnormal driving.

When the vehicle is determined to be driving abnormally, control may be performed to apply an emergency brake on the vehicle in the regulation of the behavior of the vehicle.

The occupant may be requested to apply the emergency brake on the vehicle in the event of emergency braking of the vehicle.

When the vehicle is determined to be driving abnormally, control may be performed to limit the output of the vehicle in the regulation of the behavior of the vehicle.

When the behavior of the vehicle is regulated in the regulation of the behavior of the vehicle, neighboring vehicles may be alerted thereto.

When the vehicle is determined to be driving abnormally, control may be performed to transfer driving control to the vehicle so that the occupant is enabled to drive the vehicle manually in the regulation of the behavior of the vehicle if the behavior of the vehicle is beyond control.

A driving control system for a remote driving vehicle in the present disclosure may include a detection unit collecting information required for remote driving of the vehicle; a remote control center requesting signals from the vehicle for remote driving of the vehicle by manipulating a simulator based on the information collected by the detection unit, determining whether the vehicle is driving abnormally based on the information collected by the detection unit during remote driving of the vehicle, and requesting signals to regulate the behavior of the vehicle when the vehicle is determined to be driving abnormally; and a vehicle control unit controlling the behavior of the vehicle in accordance with remote control requests and behavior regulation requests from the remote control center.

According to the present disclosure, when a vehicle is driving abnormally during remote driving, selecting fail-safe control strategies tailored to the situation and controlling the target vehicle by the selected control strategies through the problem-solving means described above prevent accidents that may occur in the abnormal driving situation, thereby having an advantage of enhancing the reliability of remote driving technology.

Specific embodiments of the present disclosure have been described in detail, but it will be obvious to those skilled in the art that various modifications and amendments are possible within the scope of the technical spirit of the present disclosure and it is natural that such modifications and revisions fall within the scope of the appended claims.

What is claimed is:

1. A method comprising:
collecting, by a controller:
vehicle information required for remote driving of a vehicle, and
request information from an occupant of the vehicle;
remotely driving, by the controller and based on the collected information, the vehicle;
determining, by the controller and based on information collected during remote driving of the vehicle, whether the vehicle is driving abnormally; and
adjusting, by the controller, a behavior of the vehicle to ensure safety based on the vehicle driving abnormally.

2. The method of claim 1, wherein the vehicle information comprises:
output information reflecting the behavior of the vehicle, and
video information obtained by capturing images inside and outside the vehicle.

3. The method of claim 1, further comprising:
collecting, based on the vehicle information or the request information not satisfying a predetermined condition, alternative information about the vehicle; and
remotely driving the vehicle based on the alternative information.

4. The method of claim 3, wherein the alternative information comprises at least one of:
location information, of the occupant, obtained through a terminal associated with the occupant, or
location information, of the vehicle, obtained through a surveillance camera installed on the vehicle.

5. The method of claim 1, wherein the determining of whether the vehicle is driving abnormally comprises:
determining that the vehicle is driving abnormally based on at least one of:
the vehicle being required to stop,
a door being opened, or
the occupant attempting to drive the vehicle manually before a destination is reached.

6. The method of claim 1, wherein the determining of whether the vehicle is driving abnormally comprises:
determining that the vehicle is driving abnormally based on at least one of:
a remote driver vacating a driver's seat, or
the remote driver remaining disengaged from driving for more than a threshold amount of time.

7. The method of claim 1, wherein the determining of whether the vehicle is driving abnormally comprises:
determining that the vehicle is driving abnormally based on at least one of:
a vehicle accident being predicted,
the vehicle accident being occurred, or
a malfunction signal of a vehicle device being generated.

8. The method of claim 1, wherein the determining of whether the vehicle is driving abnormally comprises:
determining that the vehicle is driving abnormally based on a communication disruption between the vehicle and a remote control center.

9. The method of claim 1, wherein the determining of whether the vehicle is driving abnormally comprises:
determining that the vehicle is driving abnormally based on at least one of:
a simulation device malfunctioning, or
detecting a cybersecurity issue.

10. The method of claim 1, wherein the adjusting of the behavior of the vehicle comprises:
applying an emergency brake on the vehicle.

11. The method of claim 10, wherein the applying of the emergency brake comprises requesting to the occupant to apply the emergency brake on the vehicle.

12. The method of claim 1, wherein the adjusting of the behavior of the vehicle comprises limiting a drive torque output of the vehicle.

13. The method of claim 1, wherein the adjusting of the behavior of the vehicle comprises alerting a neighboring vehicle.

14. The method of claim 1, wherein the adjusting of the behavior of the vehicle comprises transferring driving control to the vehicle such that the occupant is able to drive the vehicle manually.

15. A driving control system comprising:
a vehicle configured to collect information required for remote driving of the vehicle;
a remote control center configured to:
request signals from the vehicle;
remotely drive the vehicle by manipulating a simulator based on the information;
determine, based on the information collected by the vehicle during remote driving of the vehicle, whether the vehicle is driving abnormally; and
transmit one or more signals to the vehicle to adjust a behavior of the vehicle based on the vehicle driving abnormally,
wherein the vehicle is further configured to, based on the one or more signals, control the behavior of the vehicle.
